(19) United States
(12) Patent Application Publication
(10) Pub. No.: US 2003/0215765 A1
(43) Pub. Date: Nov. 20, 2003

(54) Oral examination apparatus containing a light, mirror and brush

(76) Inventor: Tsung-Chuan Liu, Taipei (TW)

Correspondence Address: Tsung-Chusn LIU, PO Box 82-144, Taipei, TW

(21) Appl. No.: 10/347,380

(22) Filed: Jan. 21, 2003

(30) Foreign Application Priority Data
May 17, 2002 (TW) 091207065

(51) Int. Cl. A61C 3/00

(52) U.S. Cl. 433/29; 433/31

(57) ABSTRACT

An oral examination apparatus includes a head portion including a housing on which are mounted a mirror and a brush at an upper edge thereof, and an electric torch having a light bulb at an upper end thereof engaged with a lower end of the housing, whereby by turning on the electric torch, the light bulb will provide light in a mouth and with assistance of the mirror and the brush, a user can easily observe and clean interior of his/her mouth.

### BACKGROUND OF THE INVENTION

1. Field of the Invention

This invention is related to an oral examination apparatus containing a light, mirror and brush, and in particular to one which enables a user to examine his/her mouth and teeth by him/herself, so as to keep his/her mouth in a sanitary condition.

2. Description of the Prior Art

With the rapid growth of medical instruments and technology, medical fees are increasing greatly. Many people are beginning to pay more attention to their own health, especially tooth diseases and decay, which can cause considerable discomfort and can be expensive to cure. Hence, oral hygiene is very important. However, all oral examination apparatuses on the market are designed for use by professionals, and are not suitable for ordinary people to use. Hence, it is an object of the present invention to provide an oral apparatus containing a light, mirror and brush that is easy to use for ordinary people.

SUMMARY OF THE INVENTION

This invention is related to an oral examination apparatus containing a light, mirror and brush.

It is the primary object of the present invention to provide an oral examination apparatus containing a light, mirror and brush which enables a user to examine his/her mouth and teeth by him/herself, so as to keep his/her mouth in a sanitary condition.

It is another object of the present invention to provide an oral examination apparatus containing a light, mirror and brush which includes a head portion including a housing on which are mounted a mirror and a brush at an upper edge thereof, and an electric torch having a light bulb at an upper end thereof engaged with a lower end of the housing, whereby by turning on the electric torch, the light bulb will provide light in a mouth and with assistance of the mirror and the brush, a user can easily observe and clean interior of his/her mouth.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention;

FIG. 2A is a perspective view of the present invention;

FIG. 2B is another perspective view of the present invention; and

FIG. 3 is a working view of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

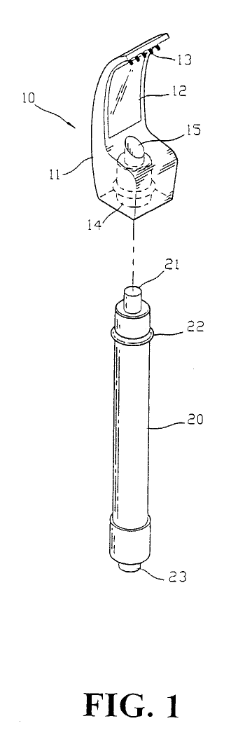

Referring to FIG. 1, the oral examination apparatus containing a light, mirror and brush according to the present invention comprises a head portion 10, which includes a housing 11 on which are mounted a mirror 12 and a brush 13 at the upper edge. The bottom of the housing 11 is formed with a recess 14 which is engageable with an upper end of an electric torch 20. The recess 14 extends upwardly through the housing 11 to form a circular hole 15 for receiving a light bulb 21 of the electric torch 20.

The electric torch 20 contains two batteries (not shown) for providing power to the light bulb 21. The lower end of the electric torch 20 is provided with a switch 23 for controlling the power supplied to the light bulb 21. The electric torch 20 is provided with a flange 22 close to the upper end thereof. The flange 22 is dimensioned to engage with a corresponding angular groove of the recess 14, so as to keep the engagement between the head portion 10 and the electric torch 20.

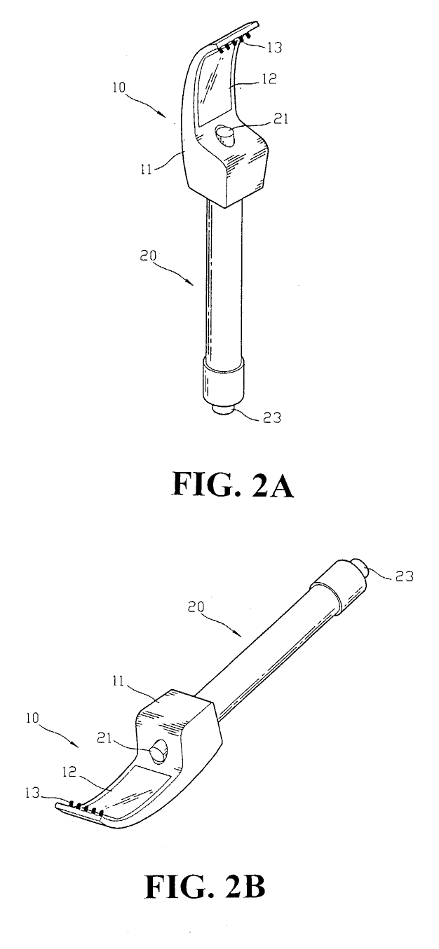

When in use, the head portion 10 is engaged with the upper end of the electric torch 20, as shown in FIGS. 2A and 2B.

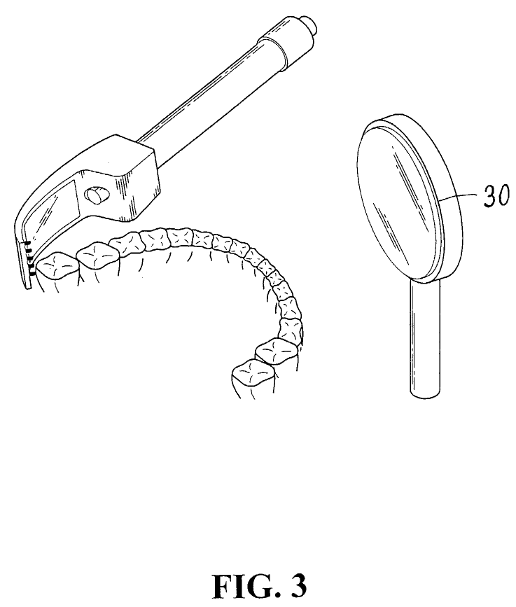

Referring to FIG. 3, the oral examination apparatus containing light, mirror and brush according to the present invention is used in union with a hand mirror 30. By turning on the electric torch 20, the light bulb 21 will provide light in the mouth and with the assistance of the mirror 12 the user can easily observe the interior of his/her mouth. The inner side of teeth is difficult to clean, and with the assistance of the mirror 12 and the brush 13, together with the hand mirror 30, one may easily clean the teeth.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An oral examination apparatus comprising:
a head portion including a housing on which are mounted a mirror and a brush at an upper edge thereof; and
an electric torch having a light bulb at an upper end thereof engaged with a lower end of said housing;
whereby by turning on said electric torch, said light bulb will provide light in a mouth and with assistance of said mirror and said brush, a user can easily observe and clean interior of his/her mouth.

2. The oral examination apparatus as claimed in claim 1, wherein said electric torch is snugly fitted with said head portion.
